(19) United States
(12) Patent Application Publication
(10) Pub. No.: US 2025/0083341 A1
(43) Pub. Date: Mar. 13, 2025

(54) WORK CELL

(71) Applicant: IDEA PROTOTIPI S.R.L., Basiliano (UD) (IT)

(72) Inventor: Massimo AGOSTINI, COSEANO (IT)

(73) Assignee: IDEA PROTOTIPI S.R.L., Basiliano (UD) (IT)

(21) Appl. No.: 18/294,881

(22) PCT Filed: Aug. 4, 2022
(86) PCT No.: PCT/IT2022/050223

§ 371 Date: Feb. 2, 2024

(30) Foreign Application Priority Data
Aug. 5, 2021 (IT) 102021000021320

(51) Int. Cl. B25J 21/00; B23Q 37/00; B25J 5/02; B25J 9/00

(52) U.S. Cl. CPC B25J 21/00; B23Q 37/007; B25J 5/02; B25J 9/0018

(57) ABSTRACT

Work cell (10), comprising a support frame (11) inside which at least one working plane (12) is obtained on which the objects to be worked are placed and at least one automatic operator device (13) configured to perform the workings on said objects.

### FIELD OF APPLICATION

The present invention relates to a work cell, which can be used to perform various types of workings by means of at least one automatic operator device, for example an anthropomorphic robot. Such workings can comprise, for example, welding, cleaning, assembling objects, or other.

### BACKGROUND ART

It is known that work cells exist which comprise a structure within which a work bench is placed on which the objects to be worked are placed, for example objects to be welded, assembled, cleaned or other.

Such cells are normally provided with an automatic operator device, for example an anthropomorphic robot, i.e., provided with six degrees of freedom and capable of reproducing almost all the movements of a human arm, including those of the hand.

A problem with the known work cells is that the automatic operator device can basically only operate on a work bench of limited size, without the possibility for example to effectively exploit the entire extension of the work cell. Therefore, such cells are normally provided with a single workstation and it is therefore extremely difficult to use for example the same work cell to perform differentiated operations.

The known work cells can therefore be improved in terms of flexibility and efficiency of use, since they are often poorly adapted to modes of use that require more work space or that require switching between different work zones within the same work cell.

Therefore, there is a need to improve a work cell which can overcome at least one of the drawbacks of the prior art.

In particular, an object of the present invention is to make a work cell which is provided with great efficiency and flexibility of use, thus it can be used for any type of working where the use of an automatic operator device is required, for example a welding, assembly, cleaning or other cell.

A further object of the present invention is to make a welding cell in which the automatic operator device has a greater working space with respect to what occurs in the known work cells.

A further object of the present invention is to provide a welding cell in which the automatic operator device can better exploit the extension of the work cell with respect to what occurs in the known work cells, thus with the possibility of creating even more workstations.

The Applicant has studied, tested and realized the present invention to overcome the drawbacks of the prior art, and to obtain the above as well as further objects and benefits.

### DISCLOSURE OF THE INVENTION

The present invention is expressed and characterized in the independent claim. The dependent claims show other features of the present invention or variants of the main solution proposed.

In accordance with the aforesaid objects, a work cell according to the invention comprises a support frame inside which at least one working plane is obtained on which the objects to be worked are placed and at least one automatic operator device configured to perform the workings on such objects.

According to a characteristic aspect of the invention, such a frame comprises a guide located at a certain height above such a working plane and such an automatic operator device comprises a support sliding along such a guide and associated with at least one drive device configured to translate such a support and thus such an automatic operator device along such a guide and thus along such a working plane.

By virtue of such a guide made in the frame of the cell and by virtue of the sliding support of the automatic operator device along such a guide, it is possible to operate on a large working plane and in particular to exploit the entire length thereof. Thereby, it is possible to obtain a work cell with greater efficiency and flexibility of use, since for example it is possible to divide the cell into several work zones, all easily accessible from the automatic operator device movable along the work cell.

According to a further aspect of the invention, such an automatic operator device is an anthropomorphic robot with six axes and six degrees of freedom and such a guide represents a seventh axis along which such an automatic operator device moves.

According to a further aspect of the invention, the work cell comprises one or more control units cooperating with such an automatic operator device and with such a drive device and associated with a control panel of the work cell.

According to a further aspect of the invention, such a working plane comprises at least one pair of work benches disposed side by side or at a certain distance from each other along such a work cell.

According to a further aspect of the invention, the work cell comprises a movable bulkhead configured to assume at least one retractable lowered position between such work benches and at least one raised position in which it separates such work benches.

According to a further aspect of the invention, such a work cell comprises one or more front doors and/or one or more lateral doors for accessing such a working plane, delimited by front and lateral walls which are recessed with respect to such front and/or lateral doors in the closed position.

According to a further aspect of the invention, such lateral doors comprise a substantially horizontal portion which, when such lateral doors are closed, aligns with such a working plane.

According to a further aspect of the invention, such a working plane comprises a work surface provided with through holes in fluid communication with one or more tanks positioned under the working plane.

According to a further aspect of the invention, the work cell comprises one or more outlets made in such tanks and connectable to a suction system of the working fluids collected therein.

According to a further aspect of the invention, the work cell comprises at least perimetrically through apertures interspersed with such through holes and each having a passage section greater than the passage section of each of such through holes.

### ILLUSTRATION OF THE DRAWINGS

These and other aspects, features and advantages of the present invention will become clear from the following embodiment disclosure, given by way of example only, with reference to the attached drawings in which:

FIG. 1 is a first axonometric front view of a work cell according to the present invention;

FIG. 2 is a further front axonometric view of the work cell;

FIG. 3 is an axonometric view of a frame of the work cell;

FIG. 4 is a further front axonometric view of the work cell;

FIG. 5 is a further rear axonometric view of the work cell;

FIG. 6 is a schematic plan view of the work cell in a working plane access configuration;

FIG. 7 is a further schematic plan view of the work cell in an operating configuration;

FIG. 8 is a view in greater scale of a detail of the working plane of FIG. 8;

FIG. 9 is a rear view of a drive device of a front door of the work cell;

FIG. 10 is a first axonometric view of a part of the drive device of FIG. 9;

FIG. 11 is a second axonometric view of a further part of the drive device of FIG. 10.

To facilitate understanding, identical reference numbers have been used, where possible, to identify identical common elements in the figures. It should be noted that elements and features of an embodiment can be conveniently combined or incorporated into other embodiments without further clarification.

### DESCRIPTION OF EMBODIMENTS

Detailed reference will now be made to the possible embodiments of the invention, one or more instances of which are shown in the attached figures by way of example only. The phraseology and terminology used herein is also exclusively for illustrative purposes.

With reference to the attached drawings, see, for example, from FIG. 1 to FIG. 4, a work cell 10 according to the present invention comprises a support frame 11 inside which at least one working plane 12 is obtained on which the objects to be worked are placed and at least one automatic operator device 13 configured to perform the workings on such objects.

Such an automatic operator device 13 can be, for example, a six-axis anthropomorphic robot and can be controlled by a control panel 14. In particular, such an automatic operator device can be a collaborative or co-robot anthropomorphic robot. Such a control panel 14 in particular can communicate with one or more control units 15 positioned in such a frame 11. Such control units 15 can be positioned for example on the top and rear of the frame 11, thus in a protected but easily accessible area. Such a control panel 14 can be installed on board the machine or remotely communicate with such control units 15. It is also possible to implement artificial intelligence systems in the present work cell 10, for operation control operations of the automatic operator device 13, maintenance or other.

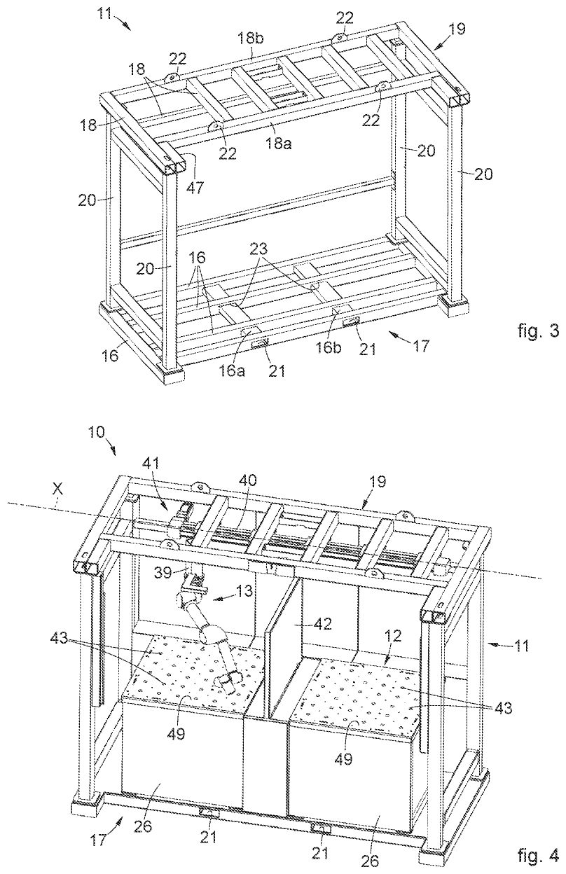

The frame 11, see in particular FIG. 4, comprises a guide 40 located at a certain height above such a working plane 12 and such an automatic operator device 13 comprises a support 39 sliding along such a guide 40 and associated with at least one drive device 41, configured to translate such a support 39 and therefore such an automatic operator device 13 along such a guide 40 and therefore along such a working plane 12.

Such a drive device 41 can be, for example, an electric motor connected to the control units 15 and can be controlled, even remotely, by means of such a control panel 14. Such a support 39 can be associated with a slide and moved along the guide 40 in any manner known per se, for example by a screw and nut screw mechanism, in which the nut screw is made in such a slide, or other and the screw is rotated by such a drive device 41.

The guide 40 is substantially directed along an axis X, which substantially represents a seventh axis along which the automatic operator device 13 can translate, which, as mentioned, can be an anthropomorphic robot having six axes and six degrees of freedom.

The guide 40 is thus in a raised position and at a certain height with respect to the working plane 12. In this regard, such a guide can be positioned along the ceiling 19.

The working plane 12 preferably comprises a pair of work benches 49, disposed side by side or at a certain distance from each other along such a work cell 10.

Access to each of the work benches 49 can be allowed by a respective front door 24.

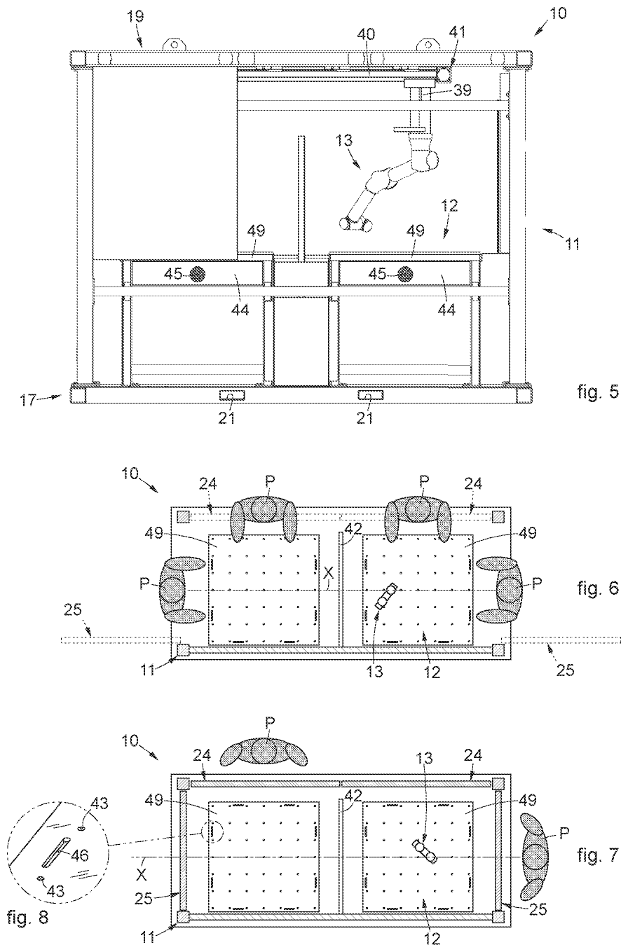

The work cell 10 comprises a bulkhead 42 positioned between such work benches 49 and configured to assume at least one raised position, see for example FIG. 4 and FIG. 5, in which it physically divides such work benches 49, for example to perform differentiated operations in each of them, and a lowered position, see for example FIG. 1, in which, in fact, there is no solution of continuity between the work benches 49. The bulkhead 42 in the lowered position is retractably housed between such work benches 49.

The working plane 12, at one or more working benches 49, comprises a work surface provided with through holes 43 in fluid communication with one or more tanks 44 positioned below the working plane 12, see in particular FIG. 5.

If, for example, the work cell 10 is used for cleaning operations, the washing fluids supplied by the automatic operator device 13 can flow through such through holes 43. If, for example, the work cell 10 is used for welding operations, the fumes resulting from the welding can be evacuated by such through holes 43, which can be associated with a suction system. For example, suction outlets 45 can be made in the tanks 44, configured to be connected to a suction system of the fluid resulting from working in the work cell 10, therefore liquids, gases or a mixture of both.

In order to allow a better evacuation of working fluids, the working plane 12 comprises perimetrically through apertures 46 interspersed with such through holes 43, see FIGS. 7 and 8. Such through apertures 46 each have a greater through-section than the through-section of each of the through holes 43.

Such a frame 11, see in particular FIG. 3, comprises first structural elements 16 of elongated shape, intersected and reciprocally integral to form a base 17 and second structural elements 18 of elongated shape, intersected and reciprocally integral to form a ceiling 19. Such a ceiling 19 and such a base 17 are joined by further structural elements 20 of elongated shape. In particular, such further structural elements 20 are arranged at the vertices of such a base 17 and of such a ceiling 19. The frame 11 further comprises first gripping elements 21, 22 provided in such a base 17 and/or in such a ceiling 19 and configured to engage with second gripping elements of a means for moving the work cell 10, such as a forklift, a crane or other.

The structural elements 16, 18 and 20 can be reciprocally integral with coupling by interlocking, screws, bolts or other so that such a frame 11 assumes a substantially box-like shape, see in particular FIG. 3.

In order to lighten such a frame 11 and make the work cell 10 even more transportable and movable, such structural elements 16, 18, 20 are tubular.

The base 17 comprises a pair of parallel and reciprocally distanced structural elements 16a, 16b in which such first gripping elements 21 are made. Such first gripping elements 21 are substantially seats configured to accommodate the arms or forks of a movement means such as a forklift or other. Such arms or forks are thus the second gripping elements.

The structural elements 16a, 16b, are directed orthogonally with respect to the remaining structural elements 16 of the base 17 and can be crossed through through holes 23 obtained in such structural elements 16.

The first gripping elements 22 can comprise a plurality of eyebolts positioned on the structural elements 18 of the ceiling 19 and configured to engage with the hooks of a moving means such as a crane or other. Such hooks are thus the second gripping elements in this example.

In particular, in such a ceiling 19, a first pair of first gripping elements 22 can be included positioned on a front structural element 18a, and a second pair of first gripping elements 22 can be included positioned on a rear structural element 18b.

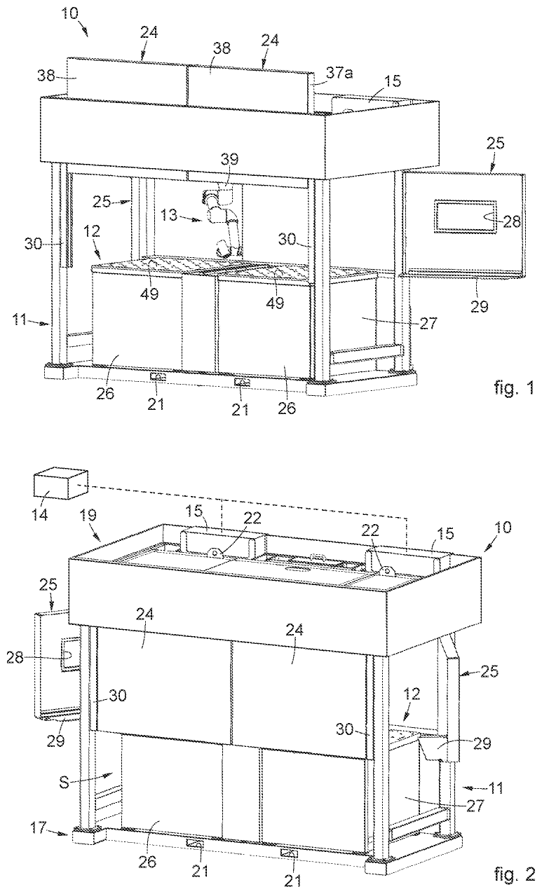

The work cell 10 comprises one or more front doors 24 and lateral doors 25 for accessing the working plane 12. Such front doors 24, as can be appreciated from the comparison of FIGS. 1 and 2, are vertically sliding. The lateral doors 25 are tilting, however alternatively it is also possible to envisage a vertical sliding. Such lateral doors 25 are also provided with a window 28 that allows the display of the interior of the work cell 10. Such lateral doors 25 can also be provided with a substantially horizontal portion 29 which, when such lateral doors 25 are closed, aligns with the working plane 12. Therefore, such a portion 29, preferably made on the lower edge of the front door 24, allows to increase the useful area of the working plane 12.

In FIG. 1, the front doors 24 are in the raised position for accessing the working plane 12, while in FIG. 2 they are in the lowered position, therefore in a working position in which the automatic operator device 13 is operational. The lateral doors 25 in this operating situation will also be closed.

Furthermore, in order to allow the passage of the front doors 24 and their positioning in the raised configuration of FIG. 1, the frame 11 comprises a recess 47 on the ceiling 19, see FIG. 3.

Such a working plane 12 is delimited by front and lateral walls 26 and 27 which are recessed with respect to the front and lateral doors 24 and 25 for accessing the working plane. Thereby, when such front and lateral doors 24 and 25 are open the operators P can have better access to the working plane 12, see FIG. 6, and when the walls 24 and 25 are closed, i.e., when the automatic operator device 13 is in operation, advantageously increase the working area present on such a working plane 12, see FIG. 7 and at the same time protect the operators P. Substantially, therefore, as can be appreciated for example from FIG. 2, around and under the working plane 12 an additional free perimeter space S is obtained, useful both in the tooling operations of the work cell 10 with front and lateral doors 24, 25 open and in the working operations with front and lateral doors 24, 25 closed.

There are preferably two front doors 24 and each of them comprises at least one substantially vertical guide 30 along which it slides to pass from the open position to the closed position or vice versa.

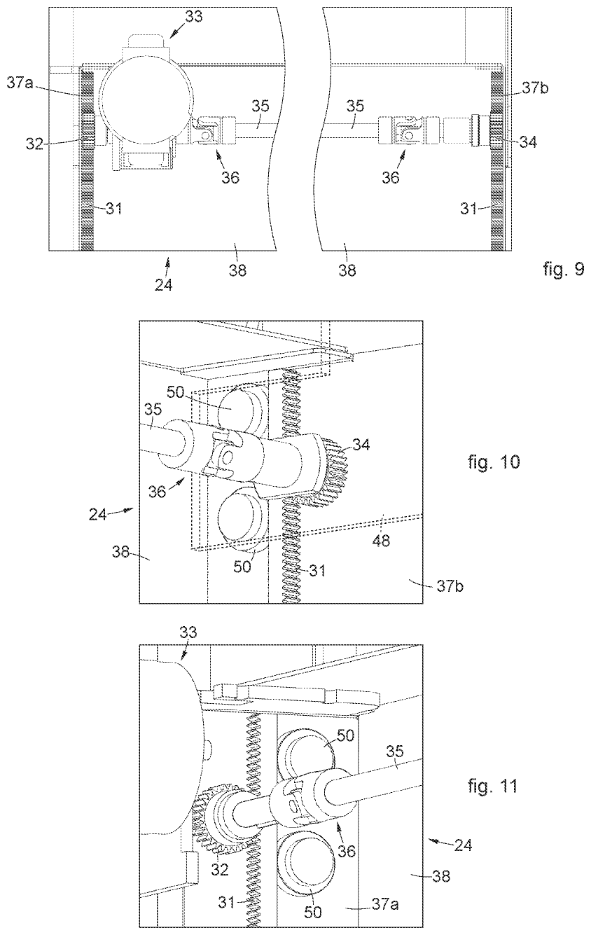

Each front door 24, see also FIGS. 9 and 10, is provided with at least one substantially vertical rack 31 and configured to engage with a first gear 32, e.g., a sprocket, set in rotation by a drive device 33. Such a drive device 33 can be an electric motor controlled by one or more control units 15.

The front door 24 can be made by means of a front wall 38 and two lateral walls 37a and 37b, substantially parallel to each other and orthogonal to the front wall 38.

In particular, it can be envisaged that the front door 24 comprises at least a first rack 31 located on a first lateral wall 37a of the front door 24 and configured to engage with such a first gear 32, and a second rack 31 located on a second lateral wall 37b opposite such a lateral wall 37a and configured to engage with a second gear 34 connected to such a first gear 32 by means of a motion transmission shaft 35. Such a shaft 35 comprises at both ends joints 36 connecting with such first and second gears 32 and 34. Such a shaft 35 is suitably installed on a fixed support 48. Each of the racks 31 of the front door 24 can further cooperate, on the smooth side opposite the toothed side, with thrust bearings 50, so as to properly maintain the vertical movement of the front door 24.

Following the start of the drive device 33, therefore, the rotation of the gears 32 and 34 causes the lifting or lowering of the racks 31 and thus of the front door 24, to which such racks 31 are fixed.

If the work cell comprises two front doors 24, each of them is provided with its own drive device 33. Such front doors 24 can thus then be opened or closed independently of one another.

The frame 11 of the present work cell 10 is very light and compact and the work cell 10 can be transported on a vehicle, for example a truck, and be easily positioned in the company or other workplace by means of the gripping elements 21, 22 of which it is equipped. Such gripping elements 21, 22 are adapted to cooperate with a movement means such as a forklift, a crane or other.

The automatic operator device 13 can advantageously be a collaborative anthropomorphic robot, or a so-called co-robot and its use is established based on the workings to be performed in the work cell 10. For example, if the work cell 10 is a welding cell, such an automatic operator device 13 will be provided with a welding head. If the work cell 10 is a cleaning cell, such an automatic operator device 13 can be provided with a cleaning head, for example provided with spray nozzles of a cleaning fluid or other.

By means of the control panel 14, it is also possible to program all the working and maintenance operations to be performed inside the work cell 10. The programming and working in the work cell 10 is very simple and intuitive by virtue of the presence of the automatic operator device 13, in particular a collaborative anthropomorphic robot.

The working field as seen can be variable, since the working plane 12 can be single or divided into a plurality of work benches 41, for example two or more work benches.

The control units 15 can also be equipped with the hardware and software necessary for the development of artificial intelligence systems, thus self-learning, so that the programming of the various works inside the work cell 10 can be freed from human intervention.

It is clear that modifications and/or additions of parts or phases may be made to the work cell described so far, without departing from the scope of the present invention as defined by the claims.

In the following claims, the references in parentheses have the sole purpose of facilitating reading and must not be considered as limiting factors as regards the scope of protection underlying the specific claims.

1: Work cell (10), comprising a support frame (11) inside which at least one working plane (12) is made on which the objects to be worked are positioned and at least one automatic operator device (13) configured to perform the workings on said objects, characterized in that said frame (11) comprises a guide (40) located at a certain height above said working plane (12) and said automatic operator device (13) comprises a support (39) sliding along said guide (40) and associated with at least one drive device (41), configured to translate said support (39) and therefore said automatic operator device (13) along said guide (40) and therefore along said working plane (12).

2: Work cell (10) as in claim 1, characterized in that the automatic operator device (13) is an anthropomorphic robot with six axes and six degrees of freedom and said guide (40) represents a seventh axis (X) along which said automatic operator device (13) moves.

3: Work cell (10) as in claim 1, characterized in that it comprises one or more control units (15) cooperating with said automatic operator device (13) and with said drive device (41) and associated with a control panel (14) of the work cell (10).

4: Work cell (10) as in claim 1, characterized in that said working plane (12) comprises at least one pair of work benches (49) disposed side by side or at a certain distance from each other along said work cell (10).

5: Work cell (10) as in claim 4, characterized in that it comprises a mobile bulkhead (42) configured to assume at least one retractable lowered position between said work benches (49) and at least one raised position in which it separates said work benches (49).

6: Work cell (10) as in claim 1, characterized in that it comprises one or more front doors (24) and/or one or more lateral doors (25) for accessing said working plane (12), which is delimited by front and lateral walls (26, 27) which are recessed with respect to said front and/or lateral doors (24, 25) in the closed position.

7: Work cell (10) claim 6, characterized in that said lateral doors (25) comprise a substantially horizontal portion (29) which, when said lateral doors (25) are closed, aligns with said working plane (12).

8: Work cell (10) as in claim 6, characterized in that said working plane (12) comprises a work surface equipped with through holes (43) in fluid communication with one or more tanks (44) positioned under the working plane (12).

9: Work cell (10) as in claim 8, characterized in that it comprises one or more outlets (45) made in said tanks (44) and connectable to a suction system for the working fluids collected therein.

10: Work cell (10) as in claim 8, characterized in that at least perimetrically it comprises through apertures (46) interspersed with said through holes (43) and each having a passage section greater than the passage section of each of said through holes (43).
